(19) United States
(12) Patent Application Publication
(10) Pub. No.: US 2009/0135597 A1
(43) Pub. Date: May 28, 2009

(54) Linear lamp

(76) Inventor: Gregory L. Kay, Chicago, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/986,887

(22) Filed: Nov. 27, 2007

(51) Int. Cl. F21V 7/00; F21V 29/02

(52) U.S. Cl. 362/247; 362/373

(57) ABSTRACT

A linear light fixture, including a longitudinal base adapted to mount on a flat surface, spaced power connectors with electrical contacts secured to the base, and a reflector secured to the base and extending longitudinally in the direction of the surface when the base is mounted to a surface. A replaceable light emitting element includes a rigid circuit board having a front surface and a back surface, a plurality of LEDs mounted on the front surface of the circuit board, a heat sink mounted to the back surface of the circuit board and adapted to conduct heat from the circuit board and LEDs, and first and second circuit board connectors projecting from one of the circuit board sides. The circuit board connectors are spaced apart so as to simultaneously snap-fit in the first and second power connectors, respectively, to selectively provide power to the circuit board through the electrical contacts.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to linear light fixtures, and more particularly to replacements for incandescent light bulbs adapted for use with such light fixtures.

### BACKGROUND OF THE INVENTION AND TECHNICAL PROBLEMS POSED BY THE PRIOR ART

Existing light fixtures using linear incandescent sources provide general illumination and accent illumination for both outdoor and indoor applications. Although relatively efficient optically, the light source is electrically inefficient. For example, current linear incandescent lamps only produce between 11-15 lumens per 1 watt of energy. Therefore, in order to get a usable amount of light, high wattage lamps are often used.

Further, incandescent linear sources produce a large amount of radiant heat while producing a small amount of visible light. Thus, linear incandescent sources can run at very high temperatures, adding burden to the cooling system in indoor applications, in addition to creating a fire hazard. Particularly as a result of the fire hazard, restrictions have been placed in many fixtures using these sources to prevent fires.

Although the lamps are typically sold in high wattages, the form factor is small, with the diameter typically being only ¼″, allowing for good optical control and small fixture sizes (with small fixture sizes allowing for a lower cost, more versatile product).

Thus, there has long been a need for a light source which produces a large amount of light in a relatively small linear package without the thermal issues associated with the current incandescent sources.

The present invention is directed toward overcoming one or more of the problems set forth above.

### SUMMARY OF THE INVENTION

According to one aspect of the present invention, a bulb replacement for an incandescent linear light fixture is provided, including a rigid circuit board, a plurality of LEDs mounted on the front surface of the circuit board, a heat sink mounted to the back surface of the circuit board and adapted to conduct heat from the circuit board and LEDs, and first and second circuit board connectors projecting from one of the circuit board sides. The circuit board connectors are spaced apart so as to be adapted to simultaneously snap-fit in fixture power connectors, respectively, to provide power to the circuit board through the electrical contacts.

In one form of this aspect of the present invention, the circuit board connectors are semicircular about an axis, and are adapted to snap-fit into electrically conductive sockets of the power connectors whereby the circuit board is supported for selective pivoting around the axis to direct light from the LEDs in a selected direction.

In another form of this aspect of the present invention, the heat sink is also the reflector.

In still another form of this aspect of the present invention, the circuit board is adapted to supply constant current to the LEDs.

In yet another form of this aspect of the present invention, the printed circuit board is adapted to supply constant current and constant voltage to the LEDs.

According to yet another form of this aspect of the present invention, the plurality of LEDs are aligned in a linear pattern and comprise first and second sets of LEDs with the LEDs of the first set alternating along the pattern with the LEDs of the second set, the first and second sets of LEDs being on parallel circuits. In a further form, the circuit board is adapted to supply constant current to the LEDs and in a still further form, the circuit board is adapted to supply constant current and constant voltage to the LEDs.

In another aspect of the present invention, a linear light fixture is provided, including a longitudinal base adapted to mount on a flat surface, spaced first and second power connectors with electrical contacts secured to the base, and a longitudinal reflector secured to the base and extending longitudinally in the direction of the surface when the base is mounted to a surface. A replaceable light emitting element includes a rigid circuit board having a front surface and a back surface, a plurality of LEDs mounted on the front surface of the circuit board, a heat sink mounted to the back surface of the circuit board and adapted to conduct heat from the circuit board and LEDs, and first and second circuit board connectors projecting from one of the circuit board sides. The circuit board connectors are spaced apart so as to simultaneously snap-fit in the first and second power connectors, respectively, to selectively provide power to the circuit board through the electrical contacts.

In one form of this aspect of the present invention, the circuit board is longitudinal, and extends longitudinally in the same direction as the reflector.

In another form of this aspect of the present invention, the circuit board connectors are semicircular about an axis, and are adapted to snap-fit into electrically conductive sockets of the power connectors whereby the circuit board is supported for selective pivoting around the axis to direct light from the LEDs in a selected direction. In a further form, the reflector is substantially arcuate about the axis in its longitudinal direction. In still another further form, a pair of insulators are located around the circuit board connectors to prevent electrical shorts with the reflector.

In another aspect of the present invention, a method of lighting a space is provided, including the steps of mounting the linear light fixture as described above to a boundary surface of the space, pivoting the circuit board to direct the LEDs in a selected orientation relative to the reflector, and selectively passing power from the first power connector, through the circuit board, to the second power connector.

### BRIEF DESCRIPTION OF THE DRAWINGS

FIG. 1 is a perspective view of a lamp replacement assembly according to the present invention;

FIG. 2 is a front view of the assembly of FIG. 1;

FIG. 3 is an end view of the assembly of FIGS. 1-2;

FIG. 4 is a top view of the assembly of claim 1;

FIG. 5 is an exploded view of the assembly of claim 1;

FIG. 6 is a perspective view of a lamp fixture and replacement assembly according to the present invention; and

FIG. 7 is a perspective view of an alternate embodiment of a lamp replacement assembly according to the present invention.

### DETAILED DESCRIPTION OF THE INVENTION

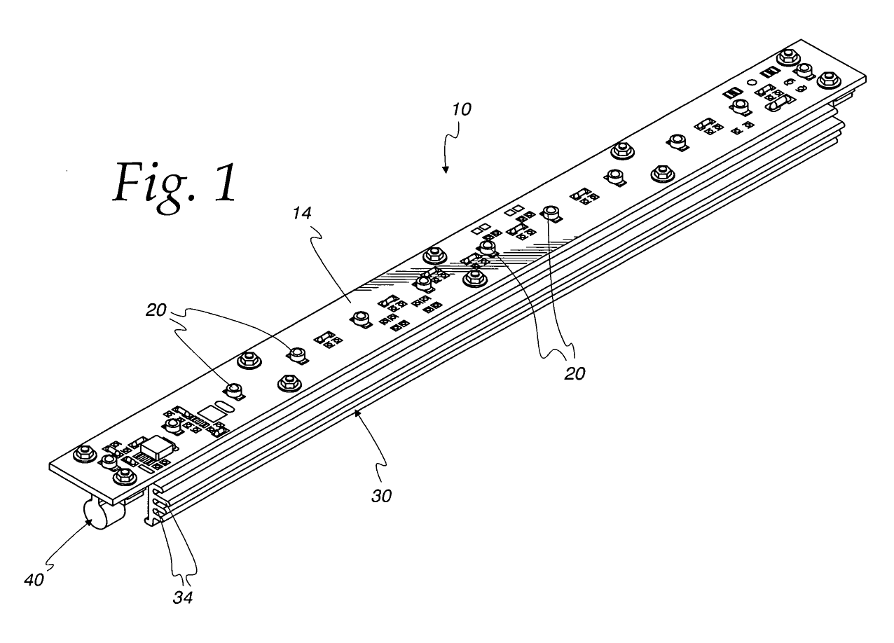

An exemplary lamp replacement assembly 10 according to the present invention is illustrated in FIGS. 1-5.

The assembly 10 includes a suitable printed circuit board 14 on which a plurality of light emitting diodes (LEDs) 20 are mounted perpendicularly thereon. Advantageously, the LEDs 20 may be arranged at substantially even spacings in a linear arrangement along the top of the circuit board 14, with the printed circuit being suitable to provide parallel circuits with alternating LEDs 20 being on the different ones of the parallel circuits. Thus, by varying the power to each circuit, such as through a control unit, the LEDs may provide different lighting, with the different lighting in all cases nonetheless being substantially uniform along the longitudinal length of the assembly 10. For any selected lighting, the circuit board 14 may be advantageously configured to supply both constant current and constant voltage to the LEDs 20 for ideal lighting effects. However, it should be appreciated that still other LED arrangements may also be provided while incorporating some aspects of the present invention, including using providing different color lighting and providing only one circuit, or more than two parallel circuits.

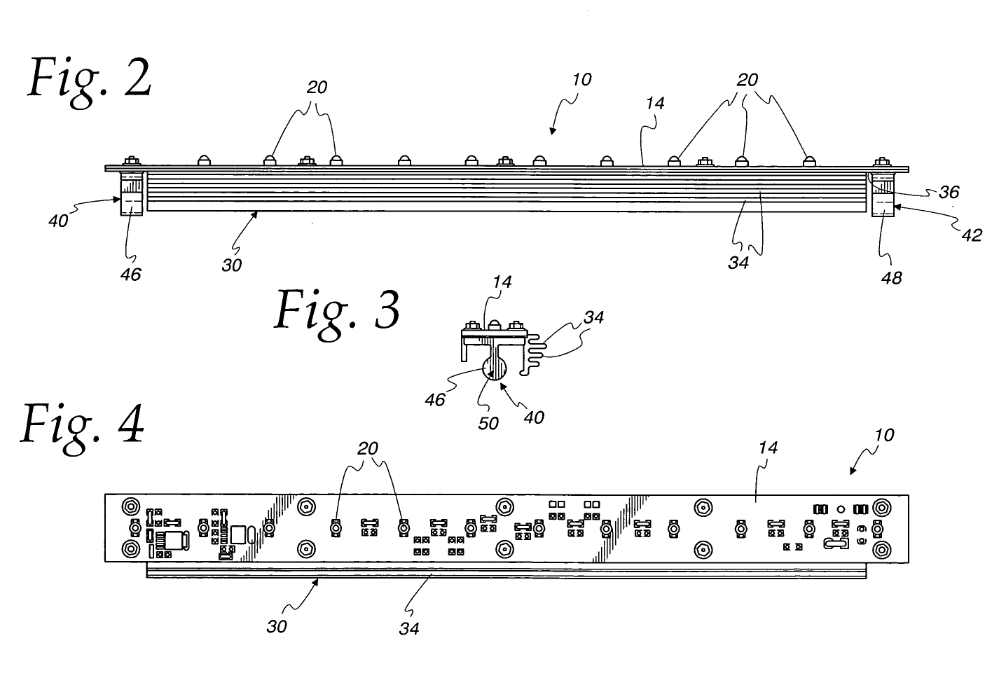

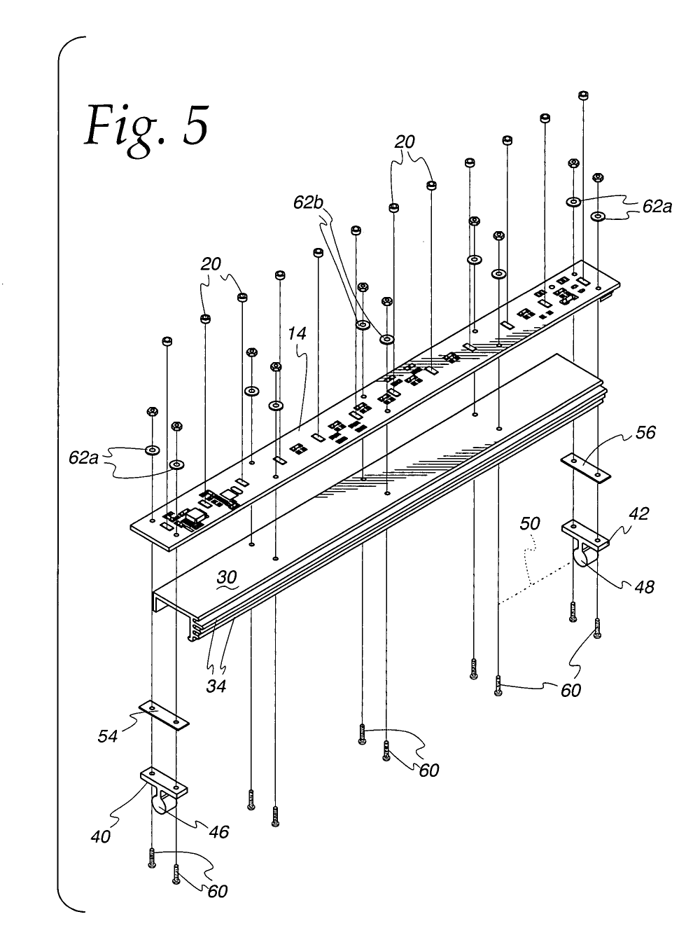

A heat sink 30 is advantageously mounted to the back surface of the circuit board 14 and is advantageously configured and adapted to conduct heat from the circuit board 14 and LEDs 20. The heat sink 30 may be reflective to facilitate lighting, and also may extend substantially the length of the circuit board 14 and include a plurality of spaced ribs 34 extending longitudinally along the heat sink 30 to facilitate cooling of the assembly 10. A thermally conductive transfer tape 36 or the like (e.g., a thermal pad, thermal grease, or other conformable material) (see FIG. 2; omitted for clarity of illustration in FIG. 5) may also be provided between the circuit board 14 and the heat sink 30 to reduce or eliminate air gaps and thereby facilitate heat transfer to the heat sink 30.

First and second circuit board connectors 40, 42 project from the bottom of the circuit board 14 and include a semicircular cylindrical portion 46, 48 aligned about an axis 50. These connectors 40, 42 may be made, for example, from nickel plated brass. Polycarbonate spacers 54, 56 may also be mounted between the circuit board 14 and the circuit board connectors 40, 42 to control electrical contact and to act as insulators to prevent electrical shorts (such as with adjacent fixture components such as a reflector, described below). Suitable rivets 60 (made, e.g., from aluminum) secure the structure together (see FIG. 5), with washers 62 included which are electrically conductive or insulating, depending on the needs of the circuit where located. For example, brass washers 62a may be used for a conductive path at the connector ends of the assembly to electrically connect the circuit board 14 at that location to the electrical connectors 40, 42, while plastic washers 62b may be used between the ends of the assembly 10 where no electrical path through the assembly 10 is required.

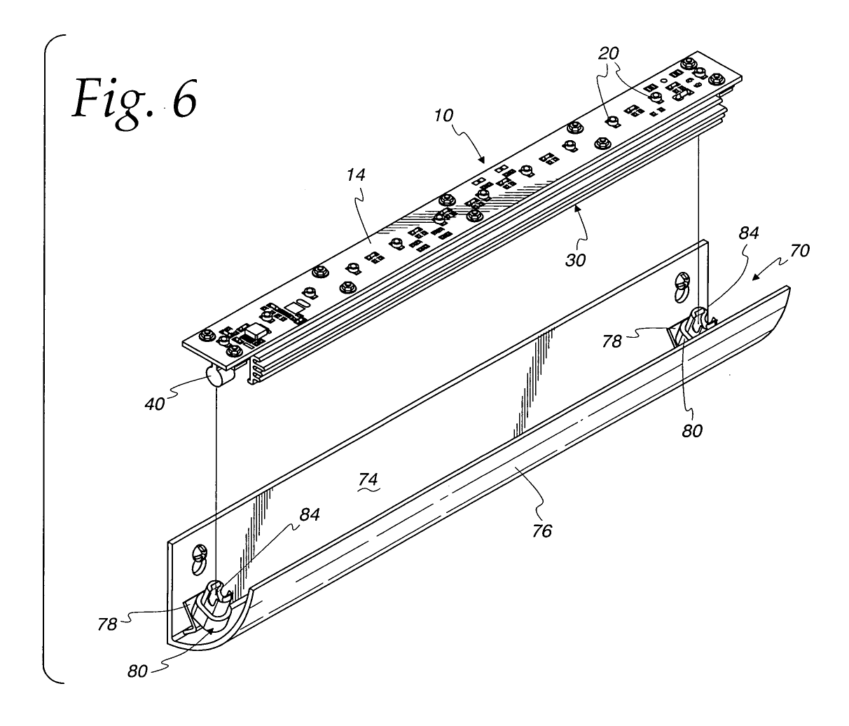

A light fixture 70 with which the replacement assembly 10 may be used is illustrated in FIG. 6. The fixture 70 includes a base plate 74 securable to a surface such as a wall, and a reflector 76 extending upwardly and curved outwardly from the bottom edge of the base plate 74. Secured to the fixture 70 by suitable brackets 78 are a pair of power connectors 80 which include suitable sockets 84 defining electrical contacts into which the circuit board connectors 40, 42 may snap-fit, with power provided to the circuit board 14 through those electrical contacts.

The size (length) of the replacement assembly 10 may vary depending on the requirements of a particular installation. Further, for longer fixtures 70, a support (not shown) may also be provided between the power connectors 80 to support the replacement assembly 10 from sagging in the middle.

When mounted together, the circuit board connectors 40, 42 and the power connectors 80 selectively provide power to the circuit board 14 through the electrical contacts. Moreover, the semicircular shape of the axially aligned circuit board connectors 40, 42 cooperate with the power connectors so that the circuit board 14 is supported for selective pivoting around the axis 50 to direct light from the LEDs 20 in a selected direction. The curve of the heat sink 30 cooperates with the curve of the reflector 76 to facilitate such variable positioning.

Still further, the circuit board 14 and LED's 20 are located above the power connectors 80, to provide advantageous positioning for the LEDs 20. With the circuit board connectors 40, 42 projecting from the bottom of the circuit board 14 as previously noted, the circuit board 14 may advantageously extend not only over the circuit board connectors 40, 42 and the sockets 84 in which the connectors 40, 42 are snap-fit (i.e., above the connectors 40, 42 and sockets 84, or spaced from the axis 50), but the circuit board 14 may also advantageously extend beyond the connectors 40, 42 and sockets 84. Thus, the circuit board 14 and LEDs 20 will not be restricted in size (e.g., length) by the space between the sockets 84, and the LEDs 20 may be provided not only between the power connectors 80 but also beyond the connectors 80, so that the location of the power connectors 80 does not restrict the length of the light. It should be appreciated, in fact, that the assembly 10 could even be spanned between the power connectors 80 of separate fixtures 70. Further, shadows in the lighting from the LEDs 20 which could arise as a result of positioning the lights in the recessed space between sockets as in the prior art are also eliminated.

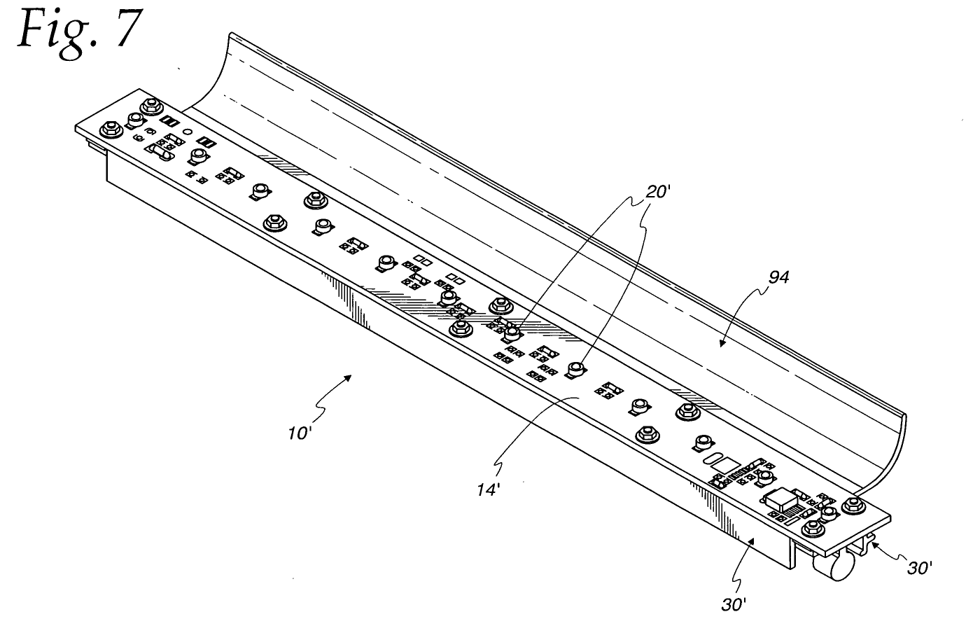

FIG. 7 illustrates an alternate embodiment of a replacement assembly 10′ in which the heat sink 30′ also includes a curved portion 90 along its length which also serves as a reflector. It should be appreciated that by fixing the reflector 90 relative to the circuit board 14′ and LEDs 20′, the orientation of the reflector 90 will automatically adjust with the orientation of the light sources (LEDs 20′) as the replacement assembly is pivoted. Further it should be appreciated that the curved portion 90 will provide additional surface area for the heat sink 30′ and therefore still further facilitate cooling.

In addition to the many above described advantages, it should also be appreciated that lamp replacement assemblies 10 may be advantageously used in place of incandescent linear lamps in light fixtures 70 such as illustrated in FIG. 6. During installation, an existing linear incandescent lamp may be removed and replaced with the replacement assembly 10 by snapping into the existing fixture or fixtures 70.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A bulb replacement for an incandescent linear light fixture having spaced first and second power connectors with electrical contacts, comprising:
a rigid circuit board having a front surface and a back surface;
a plurality of LEDs mounted on the front surface of said circuit board;
a heat sink mounted to the back surface of said circuit board and adapted to conduct heat from the circuit board and LEDs; and
first and second circuit board connectors projecting from one of said circuit board sides, said circuit board connectors being spaced apart so as to be adapted to simultaneously snap-fit in said first and second power connectors, respectively, to provide power to said circuit board through said electrical contacts.

2. The bulb replacement of claim 1, wherein said circuit board connectors are semicircular about an axis, and are adapted to snap-fit into electrically conductive sockets of said power connectors whereby said circuit board is supported for selective pivoting around said axis to direct light from the LEDs in a selected direction.

3. The bulb replacement of claim 1, where the heat sink is also the reflector.

4. The bulb replacement of claim 1, wherein the circuit board is adapted to supply constant current to the LEDs.

5. The bulb replacement of claim 1, wherein the printed circuit board is adapted to supply constant current and constant voltage to the LEDs.

6. The bulb replacement of claim 1, wherein said plurality of LEDs are aligned in a linear pattern and comprise first and second sets of LEDs with the LEDs of the first set alternating along said pattern with the LEDs of the second set, said first and second sets of LEDs being on parallel circuits.

7. The bulb replacement of claim 6, wherein the circuit board is adapted to supply constant current to the LEDs.

8. The bulb replacement of claim 6, wherein the printed circuit board is adapted to supply constant current and constant voltage to the LEDs.

9. A linear light fixture, comprising:
a longitudinal base adapted to mount on a flat surface;
spaced first and second power connectors with electrical contacts secured to said base;
a longitudinal reflector secured to said base, said reflector extending longitudinally in the direction of the surface when said base is mounted to a surface; and
a replaceable light emitting element including
a rigid circuit board having a front surface and a back surface,
a plurality of LEDs mounted on the front surface of said circuit board,
a heat sink mounted to the back surface of said circuit board and adapted to conduct heat from the circuit board and LEDs, and
first and second circuit board connectors projecting from one of said circuit board sides, said circuit board connectors being spaced apart so as to simultaneously snap-fit in said first and second power connectors, respectively, to selectively provide power to said circuit board through said electrical contacts.

10. The light fixture of claim 9, wherein the circuit board is longitudinal, and extends longitudinally in the same direction as the reflector.

11. The light fixture of claim 9, wherein said circuit board connectors are semicircular about an axis, and are adapted to snap-fit into electrically conductive sockets of said power connectors whereby said circuit board is supported for selective pivoting around said axis to direct light from the LEDs in a selected direction.

12. The light fixture of claim 11, wherein said reflector is substantially arcuate about said axis in its longitudinal direction.

13. The light fixture of claim 11, further comprising a pair of insulators located around said circuit board connectors to prevent electrical shorts with said reflector.

14. A method of lighting a space, comprising the steps of:
mounting the linear light fixture of claim 11 to a boundary surface of the space;
pivoting said circuit board to direct said LEDs in a selected orientation relative to said reflector; and
selectively passing power from said first power connector, through said circuit board, to said second power connector.
